(19) United States
(12) Patent Application Publication
(10) Pub. No.: US 2013/0160207 A1
(43) Pub. Date: Jun. 27, 2013

(54) MEDICAL BED

(71) Applicant: Shiou-Jhen Wu, Banciao City (TW)

(72) Inventor: Shiou-Jhen Wu, Banciao City (TW)

(21) Appl. No.: 13/336,792

(22) Filed: Dec. 23, 2011

(51) Int. Cl. A61G 7/002; A47C 21/08; A61G 7/00

(52) U.S. Cl. 5/600

(57) ABSTRACT

A medical bed includes a bed body, a headboard, a footboard and a bed top. The bed body has a head set and a foot set. The headboard and the footboard are attached to the head set and the foot set, respectively. The headboard and the footboard each have two ground-mounted supporting posts, a transverse bar connected between middle portions of the two supporting posts and a headboard body or a footboard body detachably mounted on the supporting posts. The headboard body and footboard body are each a plastic unity. The bed top is installed over the head set and the foot set and has an outer frame and a plurality of parallel flat planks. The medical bed can have its components compactly arranged and received in a single carton. The medical bed is structurally simple and requires reduced packing material and storage space.

### BACKGROUND OF THE INVENTION

1. Technical Field

The present invention relates to medical beds, and more particularly, to a medical bed having a structure that is compact and easy to assemble, thereby, when disassembled, requiring significantly reduced packing material and storage space.

2. Description of Related Art

Referring to FIGS. 1 through 3, an existing medical bed comprises a bed body 1, a headboard 2, a footboard 3, a bed top 4, a linkage unit 5 for lifting and lowering the bed body 1, a driving unit 6 for adjusting a reclining angle of the bed top 4, and a bedside guardrail 7 attached to the bed top 4.

For packing such a medical bed, three cartons are required, namely, the first carton for the bed body 1, the bed top 4, the linkage unit 5 and the driving unit 6, the second carton for the headboard 2 and the footboard 3, and the third carton for the bedside guardrail 7. Since the disassembled components of the existing medical bed cannot be arranged compactly and have to be held in plural cartons, the packed prior-art device is still bulky, and thus, unfavorable to transportation and storage.

In addition, some parts of the linkage unit 5 are to be installed onto an H-shaped stand 201 of the headboard 2. Therefore, referring to FIG. 2, the H-shaped stand 201 of the headboard 2 must include a transverse bar 202 for allowing a lifting mechanism 501 of the linkage unit 5 to be assembled thereto. Meantime, in the headboard 2, the board is formed by a U-like frame 203 covered by two faceplates 204 that sandwich the lifting mechanism 501 in the upper part of the H-shaped stand 201. Thus, the complicated structure and numerous parts of the lifting mechanism 501 make the assembling work of the headboard 2 inconvenient and difficult.

Now referring to FIG. 3, the bedside guardrail 7 is composed of a bedside support 701 and two long hanging arms 702 extending over the bed top 4 from the bedside support 701, so it is bulky and requires relatively high manufacturing costs.

As shown in FIG. 1, the bed top 4 is constructed from an outer frame 401 and a plurality of spring strips 402 and metal wires 403 crisscrossing within the outer frame 401. The structurally complicated spring strips 402 and metal wires 403 also add difficulty to the assembling work. Besides, such a bed top 4 formed by the spring strips is not ideal in terms of structural strength.

Additionally, since the frames of the head set 101 and the foot set 102 of the bed body 1 are both constructed with L-shaped steel angles 103, their structural strength is also poor.

### BRIEF SUMMARY OF THE INVENTION

The present invention provides a medical bed, which is structurally compact and, after disassembled, has components thereof being readily to be arranged compactly in a single carton, so the disclosed medical bed requires significantly reduced packing material and storage space.

According to the present invention, the medical bed comprises a bed body, a headboard, a footboard, a bed top, a driving unit and a bedside guardrail. The bed body has a head set and a foot set that are configured to dock with each other and thereby jointly form the bed body. The headboard is attached to the head set from outside and has two ground-mounted supporting posts, a transverse bar connected between middle portions of the two supporting posts and a headboard body detachably mounted on the supporting posts, wherein the headboard body is formed as a unity from plastic. The footboard is attached to the foot set from outside and has two ground-mounted supporting posts, a transverse bar connected between middle portions of the two supporting posts and a headboard body detachably mounted on the supporting posts, wherein the footboard body is formed as a unity from plastic. The bed top is installed over the head set and the foot set and having an outer frame and a plurality of parallel flat planks arranged within the outer frame.

### BRIEF DESCRIPTION OF THE SEVERAL VIEWS OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a perspective view of an existing medical bed;

FIG. 2 is an exploded view of a headboard in the existing medical bed, wherein a lifting mechanism is illustrated in detail;

FIG. 3 is a partial assembled view of a bedside guardrail of the existing medical bed;

FIG. 4 is a perspective view of a medical bed according to one embodiment of the present invention;

FIG. 5 is an exploded view of a headboard and a footboard according to the embodiment of the present invention;

FIG. 6 is a schematic drawing showing hollow frames of the head set and the foot set of the bed body according to the embodiment of the present invention;

FIG. 7 is a partial assembled view of a bedside guardrail according to the embodiment of the present invention; and

FIG. 8 is a perspective view of the medical bed being disassembled and retracted according to the embodiment of the present invention.

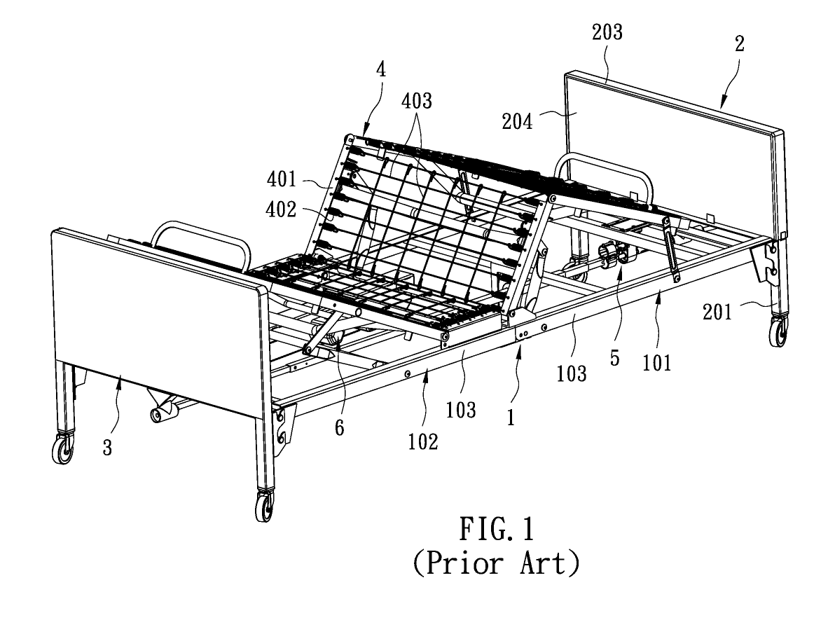

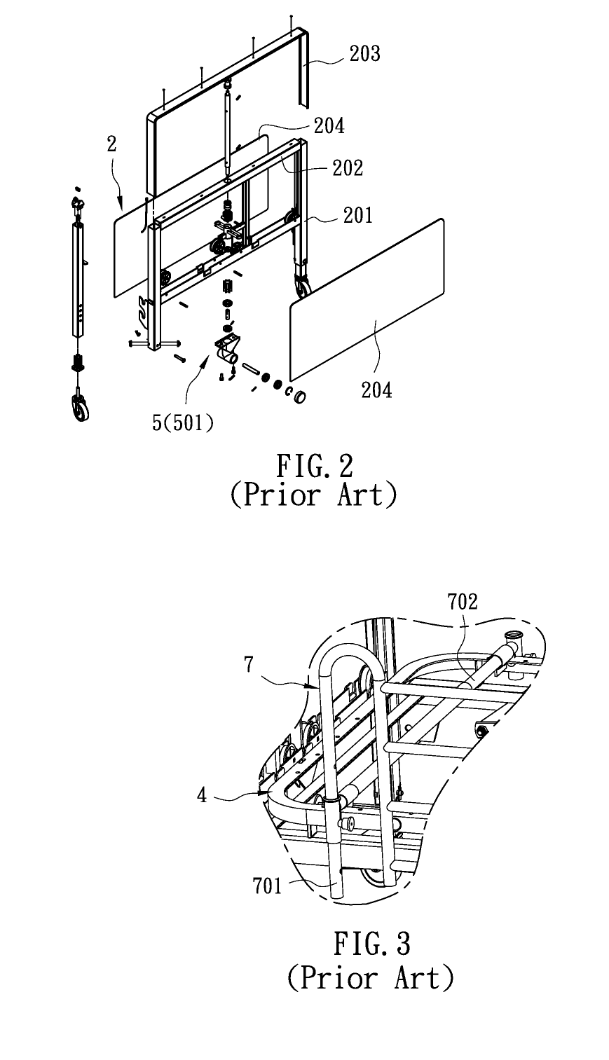

### DETAILED DESCRIPTION OF THE INVENTION

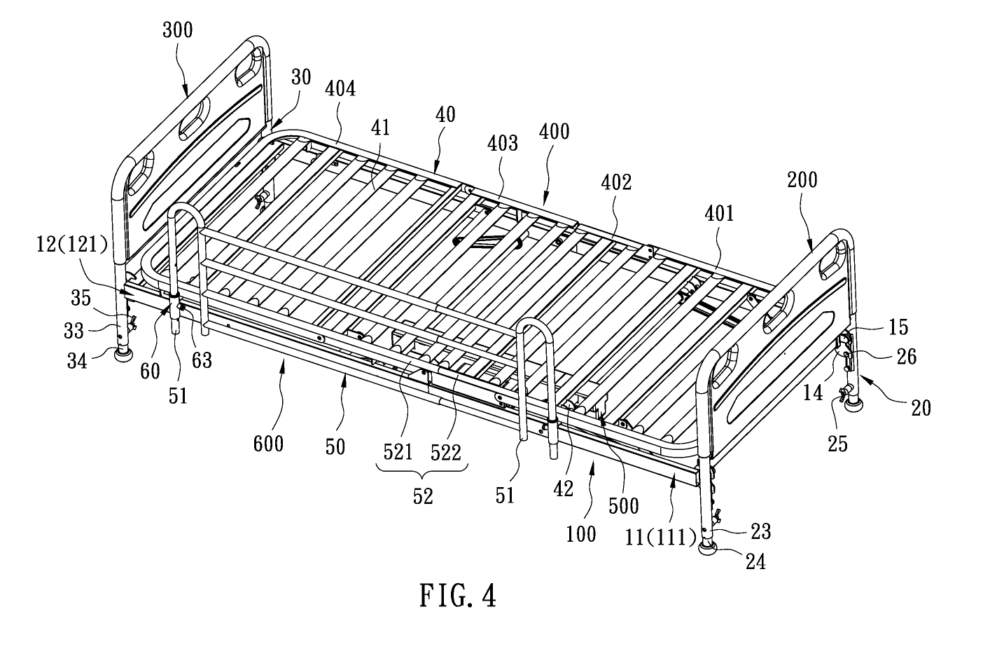

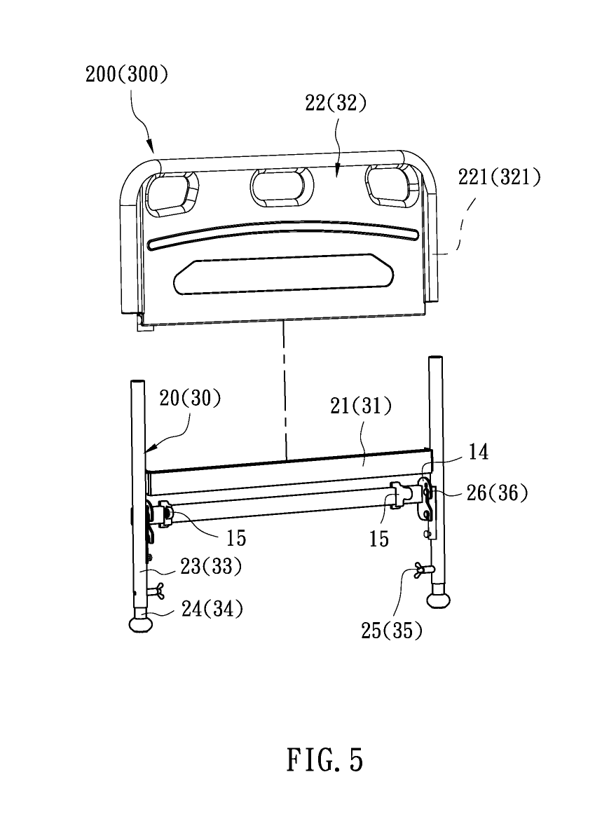

Referring to FIG. 4 and FIG. 5, in one embodiment of the present invention, a medical bed comprises a bed body 100, a headboard 200, a footboard 300, a bed top 400, a driving unit 500 and a bedside guardrail 600.

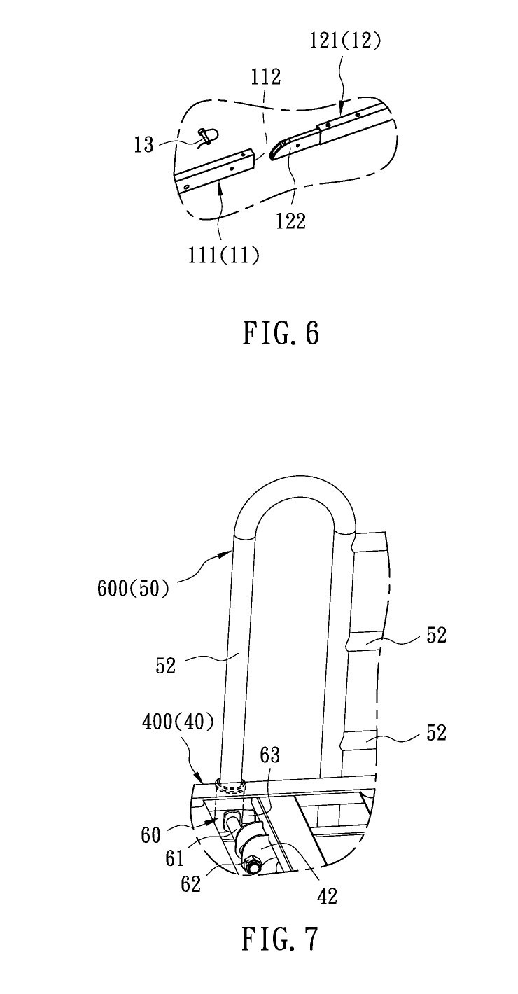

The bed body 100 includes a head set 11 and a foot set 12, which are configured to dock with each other and thereby jointly form the bed body 100. The head set 11 has a hollow, reverse U-shaped frame 111 and two receiving sockets 112 (FIG. 6) each provided at an open end of the hollow frame 111.

As shown in FIG. 6, the foot set 12 has a reverse U-shaped hollow frame 121 and two connecting segments 122 each provided at an open end of the hollow frame 121. The connecting segment 122 of the foot set 12 is configured to be inserted into the corresponding receiving socket 112 of the head set 11, such that a pin 13 can be installed to fix the connecting segment 122 of the foot set 12 to the head set 11. It is to be noted that both of the hollow frames 111, 121 of the head set 11 and the foot set 12 have a rectangular cross-section.

The headboard 200 is attached to the head set 11 from outside. The headboard 200 comprises two ground-mounted supporting posts 20, a transverse bar 21 connected between middle portions of the two supporting posts 20 and a headboard body 22 detachably mounted on the supporting posts 20. The headboard body 22 is formed as a unity from plastic. The headboard body 22 of the headboard 200 has two receiving sleeves 221 at two laterals thereof such that the headboard body 22 can be mounted on the supporting posts 20 of the headboard 200 by means of the receiving sleeves 221.

The footboard 300 is attached to the foot set 12 from outside. The footboard 300 comprises two ground-mounted supporting posts 30, a transverse bar 31 connected between middle portions of the two supporting post 30 and a footboard body 32 detachably mounted on the supporting posts 30. The footboard body 32 is formed as a unity from plastic. The footboard body 32 of the footboard 300 has two receiving sleeves 321 at two laterals thereof such that the footboard body 32 can be mounted on the supporting posts 30 of the headboard 300 by means of the receiving sleeve 321.

Each of the supporting posts 20, 30 of the headboard 200 and the footboard 300 is composed of an outer tube 23 or 33, an inner tube 24 or 34 and a fixing pin 25 or 35 for height adjustment. The transverse bars 21, 31 are connected between the outer tubes 23, 33 of the paired supporting posts 20, 30.

Each of the head set 11 and the foot set 12 of the bed body 100 has a set of positioning piece 14 and fixing cap 15 provided near each of its laterals. Correspondingly, in the headboard 200 and the footboard 300, each of the supporting posts 20, 30 has its middle portion provided with a node 26 or 36. By engaging the positioning pieces 14 with the nodes 26, 36, the headboard 200 and the footboard 300 can be positioned on the head set 11 and foot set 12, respectively. Then the fixing caps 15 can be mounted around the nodes 26, 36 of the head set 11 and the foot set 12, so as to firmly secure the combination between the head set 11 and headboard 200 and the combination between the foot set 12 and the footboard 300.

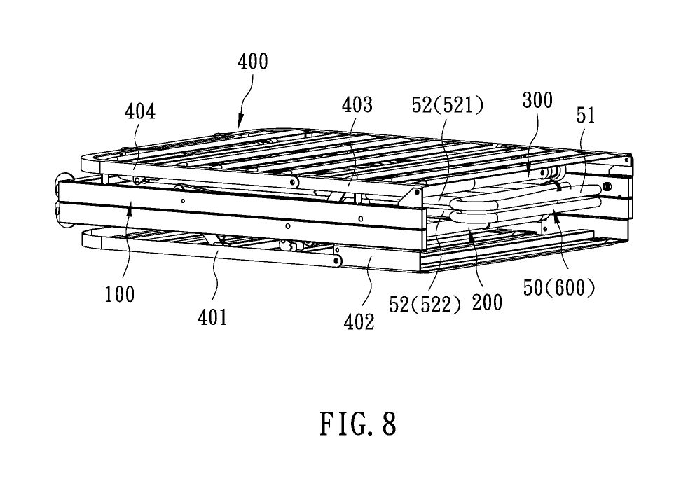

The bed top 400 is installed over the head set 200 and the foot set 300. The bed top 400 includes an outer frame 40 and a plurality of parallel flat planks 41 arranged within the outer frame 40. The bed top 400 includes four segments 401, 402, 403 and 404, which are configured to be folded into the status as shown in FIG. 8. The driving unit 500 is assembled below the bed top 400 for driving the bed top 400 to change its reclining angle.

Referring to FIG. 4 and FIG. 7, the bedside guardrail 600 has a guardrail body 50 and a plurality of tubular sockets 60 attached to a periphery of the outer frame 40 of the bed top 400. The guardrail body 50 comprises two reverse U-shaped side brackets 51 and a plurality of railings 52 connected between the two side brackets 51. The side brackets 52 of the guardrail body 50 are inserted into and thereby positioned by the tubular sockets 60. Each of the tubular sockets 60 has a bolt 61 extending therefrom so that a nut 62 can work with the bolt 61 to hold a set of lug 42 of the bed top 400, thereby fixing the tubular sockets 60 to the bed top 400. An adjusting button 63 is provided at a lateral of the tubular socket 60 for lifting or lowering the guardrail body 50. Each of the railings 52 of the bedside guardrail 600 is composed of an outer tube 521 and an inner tube 522 that are telescoped. The outer tube 521 and the inner tube 522 each have an outer end connected to the corresponding reverse U-shaped side bracket 51.

With the understanding to the above description, one can better learn the functions and operation of the disclosed medical bed through the following paragraphs.

In the bed top 400, the two outer segments 401, 404 and the two inner segments 402, 403 are generally symmetrical. Thus, for packing the medical bed, the unassembled bed body 100 (including the driving unit 500 attached there below), the headboard 200, the footboard 300 and the bedside guardrail 600 can be compactly arranged and received between the folded and stacked segments 401-404 of the bed top, so only a single carton is sufficient to pack all the components. As compared with the existing medical bed that is inconvenience in storage and requires three cartons for its packing, the medical bed of the present invention can be easily packed into a compact size, facilitating saving costs for packing.

The height adjustment of the head set and foot set is simply realized by operating the inner and outer tubes 23(33), 24(34) of the H-shaped supporting post 20, 30 together with the fixing pins 25(35), so the present invention is advantageous for its simple structure and easy operation. In addition, the headboard body 22 and the footboard body 32 are each a plastic unity that can be easily assembled to or disassembled from the H-shaped supporting post 20 or 30 through an inserting/drawing motion, so the present invention is advantageous for quick assembling work, easy manufacturing and neat appearance.

The present invention implements the simple mechanism composed of the inner and outer tubes as well as the fixing pins instead of the lifting mechanism with numerous parts used in the existing medical bed. Thereby, the disclosed medical bed can achieve height adjustment of the bed head and bed end with significantly reduced components. Thus, the overall weight of the disclosed medical bed can be significantly reduced to facilitate transportation in terms of operation and cost.

The bedside guardrail 600 of the present invention is positioned at the edge of the bed body 100 through only the tubular sockets 60. As compared to the existing medical bed that uses two tandem long hanging arms to hold its guardrail, the present invention has the bedside guardrail 600 structurally simpler, so is helpful to save costs for materials.

As described above, the existing medical bed has its bed body constructed from L-shaped steel angles. On other hand, the head set and foot set of the bed body of the present invention are made from rectangular tubes, and therefore are easy to manufacture and have good strength. In addition, the foot set 12 and the head set 11 can be rapidly combined by docking the connecting segments 122 at the receiving sockets and installing the pins 13 thereon, so the assembling work is more facile.

The supporting posts 20, 30 of the headboard 200 and the footboard 300 of the present invention are simply H-shaped without the transverse bar used in the existing headboard for carrying the lifting mechanism, so the present invention is advantageous for saving materials and costs.

According to the present invention, the combination of the bed body and the headboard or the footboard is achieved by the engagement between the positioning pieces 14 and the nodes 26 or 36, and further secured by the fixing caps 15 mounted around the nodes 26 or 36, so that the combination between the head set 11 and headboard 200 and the combination between the foot set 12 and the footboard 300 can be ensured with enduring firmness. In addition, the positioning pieces 14 and the nodes 26, 36 of the present invention are located either near the laterals of the headboard and the footboard or near the edges of the head set and the foot set so they are almost not visible under the normal use of the medical bed. This not only ensures pleasing appearance but also protects the components from unintentional damage.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A medical bed, comprising:
a bed body having a head set and a foot set that arc configured to dock with the head set and thereby form the bed body;
a headboard being attached to the head set from outside and having two ground-mounted supporting posts, a transverse bar connected between middle portions of the two supporting posts and a headboard body detachably mounted on the supporting posts, wherein the headboard body is formed as a unity from plastic;
a footboard being attached to the foot set from outside and having two ground-mounted supporting posts, a transverse bar connected between middle portions of the two supporting posts and a footboard body detachably mounted on the supporting posts, wherein the footboard body is formed as a unity from plastic;
a bed top including a frame and a plurality of parallel flat planks arranged within the frame, wherein the bed to includes first and second segments placed above and connected to the head set and third and fourth segments placed above and connected to the foot set; and
a guardrail including sockets secured to the frame of the bed to and a guardrail body including two side brackets for insertion in the sockets and foldable railings for interconnecting the side brackets, wherein the head set can be detached from the foot set, and the headboard can be detached from the head set, and the footboard can be detached from the foot set, and the guardrail can be detached from the bed to and folded, thus allowing the head set, the foot set, the headboard, the footboard and the guardrail to be placed between a combination of the first segment with the second segment of the bed to and a combination of the third segment with the fourth segment of the bed to so that all of the elements can be contained in a single carton.

2. The medical bed of claim 1, wherein the headboard body of the headboard has two receiving sleeves at two laterals thereof such that the headboard body is allowed to be mounted on the supporting posts of the headboard by means of the receiving sleeves.

3. The medical bed of claim 1, wherein the head set has a hollow, reverse U-shaped frame and two receiving sockets each provided at an open end of the hollow frame, and the foot set has a hollow, reverse U-shaped frame and two connecting segments each provided at an open end of the hollow frame, such that when the connecting segments of the foot set are inserted into the receiving sockets of the head set and pins are installed to fix the connecting segments of the foot set to the head set.

4. The medical bed of claim 3, wherein each of the hollow frames of the head set and the foot set has a rectangular cross-section.

5. The medical bed of claim 1, wherein each of the supporting posts of the headboard and the footboard is composed of an outer tube, an inner tube and a fixing pin for height adjustment, and the transverse bars are connected between the two outer tubes of the paired supporting posts.

6. The medical bed of claim 1, wherein each of the head set and the foot set of the bed body has a positioning piece provided near each lateral thereof, and each of the supporting posts of the headboard and the footboard has on the middle portion thereof a node, such that by engaging the positioning pieces with the nodes, the headboard and the footboard are positioned on the head set and the foot set, respectively.

7. The medical bed of claim 6, further comprising a plurality of fixing caps, each said fixing cap being configured to be mounted around one said node of the head set or the foot set of the bed body.

8. (canceled)

9. (canceled)

10. The medical bed of claim 1, further comprising a driving unit connected to the bed top for driving the bed top to change a reclining angle thereof.
